(19) United States
(12) Patent Application Publication
(10) Pub. No.: US 2023/0364928 A1
(43) Pub. Date: Nov. 16, 2023

(54) INKJET INK, METHOD FOR MANUFACTURING PRINTED MATERIAL, AND PRINTED MATERIAL

(71) Applicant: NATOCO CO., LTD., AIchi (JP)

(72) Inventors: Takashi ENDO, Miyoshi-shi, Aichi (JP); Katsumi HARA, Miyoshi-shi, Aichi (JP)

(21) Appl. No.: 18/024,398

(22) PCT Filed: Jul. 13, 2021
(86) PCT No.: PCT/JP2021/026299

§ 371 Date: Mar. 2, 2023

(30) Foreign Application Priority Data
Sep. 8, 2020 (JP) 2020-150318

(51) Int. Cl. B41J 11/00; C09D 11/38; C09D 11/322; C09D 11/101; C09D 11/102

(52) U.S. Cl. CPC B41J 11/002; C09D 11/38; C09D 11/322; C09D 11/101; C09D 11/102

(57) ABSTRACT

An inkjet ink containing scale-like metal particles is provided. An average major axis of the scale-like metal particles is equal to or less than 400 nm (preferably 50 to 200 nm). Furthermore, the inkjet ink contains 2 to 10 mass % of the scale-like metal particles. The scale-like metal particles preferably include indium and/or chromium. The inkjet ink may be a radical polymerization type or a cationic polymerization type.

### TECHNICAL FIELD

The present invention relates to an inkjet ink, a method for manufacturing a printed material, and a printed material. More specifically, the present invention relates to an inkjet ink containing scale-like metal particles, a method for manufacturing a printed material using the inkjet ink, and a printed material having a cured product of the inkjet ink.

### BACKGROUND ART

Drawing an image having metallic gloss on the surface of an article by an inkjet method has been studied.

Conventionally, “foil stamping” has been the mainstream of a method for drawing an image having metallic gloss to the surface of an article. However, foil stamping tends to be a complicated step and is unsuitable for coping with multi-product small-batch production. Accordingly, an inkjet method, which is relatively simple and suitable for multi-product small-batch production, is being studied to draw an image having metallic gloss on the surface of an article.

Patent Document 1 discloses an ink composition for ultraviolet-curable-type inkjet which contains an aluminum pigment, phenoxyethyl (meth)acrylate, and ricinoleic acid triglyceride phosphate ester. In this composition, the ricinoleic acid triglyceride phosphate ester is contained in an amount of equal to or more than 0.05 mass % and equal to or less than 5 mass % with respect to the total mass of the ink composition. Furthermore, in this composition, the aluminum pigment is flat plate-like particles having an average thickness of equal to or more than 5 nm and equal to or less than 30 nm and having a 50% average particle diameter of equal to or more than 0.5 μm and equal to or less than 3 μm.

Patent Document 2 discloses an ink composition characterized by containing aluminum scale-like metal particles (component A), a cationically polymerizable compound (component B), and a photocationic polymerization initiator (component C), in which the component B is occupied by 15% to 99. 9% by weight of a polyfunctional monomer.

Patent Document 3 discloses an active energy ray-curable-type ink composition containing at least scale-like metal particles (A), a polymerizable compound (B), and a photopolymerization initiator (C). The L* value of the liquid interface of this active energy ray-curable-type ink composition is equal to or more than 30. Furthermore, in the scale-like metal particles (A), a 50% volume average diameter is equal to or more than 0.05 and less than 0.5 μm, an average thickness is equal to or more than 5.0 and less than 50.0 nm, and an aspect ratio (50% volume average diameter/average thickness) is equal to or more than 4 and equal to or less than 50.

Patent Document 4 discloses an image forming method including a white ink applying step of applying a white ink containing a polymer and a metal oxide having a number average diameter of equal to or more than 200 nm and equal to or less than 700 nm to a recording medium, and a lustrous ink applying step of applying a lustrous ink containing a lustrous pigment to a region on the recording medium to which the white ink has been applied. Herein, the volume Vp of the metal oxide in the white ink and the volume Ve of the polymer in the white ink satisfy 0.6≤Vp/(Vp+Ve).

Patent Document 5 discloses an image formed product having a base material, a foundation layer formed on the surface of the base material, and an ink layer formed to be in contact with the foundation layer. Herein, the ink layer having a film thickness of equal to or more than 100 nm is an aggregation of a plurality of dots containing metal nanoparticles.

Patent Document 6 discloses an edible ink containing polyvinylpyrrolidone and silver.

Patent Document 7 discloses a lustrous inkjet ink containing metal nanoparticles, a dispersant adsorbed on the surfaces of the metal nanoparticles, emulsion resin particles, and a solvent. Herein, 0.05<D2/D1<1 is satisfied when D1 is the average particle diameter of the metal nanoparticles and D2 is the average particle diameter of the emulsion resin particles.

### RELATED DOCUMENT

### Patent Document

[Patent Document 1] Japanese Laid-open Patent Publication No. 2012-102295

[Patent Document 2] Japanese Laid-open Patent Publication No. 2012-46577

[Patent Document 3] Japanese Patent No. 6672432

[Patent Document 4] Japanese Laid-open Patent Publication No. 2019-155598

[Patent Document 5] Japanese Laid-open Patent Publication No. 2019-162741

[Patent Document 6] Japanese Laid-open Patent Publication No. 2020-2338

[Patent Document 7] International Publication No. WO2018/181080

### SUMMARY OF THE INVENTION

### Technical Problem

As described above, various studies have been made to provide an image having metallic gloss on the surface of an article by the inkjet method.

However, while the inventors of the present invention were promoting the improvement of an inkjet ink containing scale-like metal particles, it became clear that satellite droplets are likely to be generated when the concentration of the scale-like metal particles is increased in order to increase the level of metallic gloss of a printed image. In other words, in preliminary studies by the inventors of the present invention, there was a trade-off relationship between the level of metallic gloss of a printed image and the generation of satellite droplets.

The present invention has been made in view of such circumstances. An object of the present invention is to provide an inkjet ink which is less likely to cause the generation of satellite droplets and which can provide an image having a high level of metallic gloss.

### Solution to Problem

The inventors of the present invention have completed the invention provided below to achieve the above-mentioned object.

According to the present invention, the following aspect is provided.

An inkjet ink containing: scale-like metal particles,

in which an average major axis of the scale-like metal particles is equal to or less than 400 nm, and

the inkjet ink contains 2 to 10 mass % of the scale-like metal particles.

According to the present invention, the following aspect is further provided.

A method for manufacturing a printed material, the method including:

an image forming step of jetting the above-mentioned inkjet ink onto a surface of a base material to form an image; and

a curing step of curing the above-mentioned jetted inkjet ink.

According to the present invention, the following aspect is still further provided.

A printed material having a cured product of the above-mentioned inkjet ink.

### Advantageous Effects of Invention

According to the present invention, an inkjet ink which is less likely to cause the generation of satellite droplets and which can provide an image having a high level of metallic gloss is provided.

### BRIEF DESCRIPTION OF THE DRAWINGS

FIG. 1 is a reference diagram for describing a method for evaluating satellite droplets in Examples.

### DESCRIPTION OF EMBODIMENTS

Hereinafter, embodiments of the present invention will be described in detail with reference to the drawing.

The drawing is for description purposes only. Shapes, dimensional ratios, and the like of each member in the drawing do not necessarily correspond to actual articles.

In the present specification, the notation “X to Y” in the description of a numerical value range represents equal to or more than X and equal to or less than Y, unless otherwise specified. For example, “1 to 5 mass %” means “equal to or more than 1 mass % and equal to or less than 5 mass %”.

In the indication of groups (atomic group) in the present specification, the indication not including substitution or unsubstitution includes both groups not having a substituent and groups having a substituent. For example, an “alkyl group” refers not only to an alkyl group not having a substituent (unsubstituted alkyl group) but also to an alkyl group having a substituent (substituted alkyl group).

The expression “(meth)acrylic” in the present specification represents a concept including both acrylic and methacrylic. The same applies to similar notations such as “(meth)acrylate”.

The term “organic group” in the present specification means an atomic group obtained by removing one or more hydrogen atoms from an organic compound, unless otherwise specified. For example, a “monovalent organic group” represents an atomic group obtained by removing one hydrogen atom from an arbitrary organic compound.

### Inkjet Ink

An inkjet ink of the present embodiment contains scale-like metal particles.

The average major axis of the scale-like metal particles is equal to or less than 400 nm.

Furthermore, the inkjet ink contains 2 to 10 mass % of the scale-like metal particles.

As described above, conventionally, when the concentration of a metallic pigment is increased in an attempt to increase the level of metallic gloss, satellite droplets tend to occur, making it difficult to achieve compatibility between a favorable level of metallic gloss and reduced satellites. This is presumed to be because when the pigment concentration is increased, ligaments (tail-like portions formed behind liquid droplets jetted from an inkjet head) become easier to cut. Specifically, it is presumed that when the pigment concentration is increased, the “cohesion” of an ink deteriorates, resulting in an increase in the number of small liquid droplets (that is, satellite droplets) that are not absorbed by main droplets.

In particular, it is thought that when scale-like metal particles are used as pigments in order to obtain metallic gloss, a unique “scale-like” shape of the scale-like metal particles greatly affects the “cohesion” and “flow characteristics” of an ink, as compared to spherical particles. Therefore, it is presumed that the use of the scale-like metal particles facilitates the generation of satellite droplets.

Based on the above-mentioned description, the present embodiment employs the scale-like metal particles having an average major axis of equal to or less than 400 nm. By employing the relatively small scale-like metal particles having an average major axis of equal to or less than 400 nm, the “cohesion” of the ink becomes favorable, and satellite droplets are less likely to be generated. Therefore, even when the concentration of the scale-like metal particles is 2 to 10 mass %, satellite droplets are less likely to be generated. Furthermore, because a relatively large amount of the scale-like metal particles can be used, a printed material having a favorable level of metallic gloss can be obtained.

Furthermore, in the present embodiment, since the metal particles are “scale-like”, metallic gloss is more easily obtained (as compared to spherical metal particles of the same amount).

For the sake of precaution, it should be noted that as far as the findings of the inventors of the present invention is concerned, even when using the “relatively small” scale-like metal particles having an average major axis of equal to or less than 400 nm, a printed material having a sufficient level of metallic gloss can be obtained when the inkjet ink contains a sufficient amount, that is, 2 to 10 mass of the scale-like metal particles.

Components contained, physical properties, and the like of the inkjet ink of the present embodiment will be specifically described below.

### Scale-Like Metal Particles

The inkjet ink of the present embodiment contains the scale-like metal particles. The term “scale-like” means a concept including shapes such as flat plate-like and curved plate-like. Specifically, it refers to a shape in which the area when observed in one direction (when seen in a plan view) is larger than the area when observed in a direction orthogonal to that direction.

In the scale-like metal particles, the aspect ratio obtained by calculating (average major axis/average thickness) is preferably equal to or more than 2, more preferably equal to or more than 2.5, further preferably equal to or more than 3, and particularly preferably equal to or more than 3.5. Although the upper limit of the aspect ratio is not particularly limited, the upper limit is equal to or less than 100, preferably equal to or less than 75, more preferably equal to or less than 50, and particularly preferably equal to or less than 25, for example.

The average major axis of the scale-like metal particles may be equal to or less than 400 nm, preferably 50 to 400 nm, more preferably 50 to 350 nm, further preferably 50 to 200 nm, and particularly preferably 100 to 200 nm. By using the scale-like metal particles having a relatively small average major axis, the generation of satellite droplets is more easily prevented.

The average thickness of the scale-like metal particles is preferably 10 to 50 nm, and more preferably 20 to 40 nm.

The “average major axis” can be obtained by capturing an image of the scale-like metal particles using an electron microscope, and averaging the major axes of arbitrary 50 scale-like metal particles in the captured image. The same applies to the “average thickness”.

By using the scale-like metal particles having an appropriate average major axis, average thickness, or aspect ratio, the level of metallic gloss of a final printed material can be further increased while maintaining the inkjet performance (such as jettability).

The scale-like metal particles can include one or two or more of metals such as indium, chromium, silver, and aluminum, for example. Among these, indium and/or chromium is preferably included.

The scale-like metal particles of indium and/or chromium have an advantage in that particles having the above-mentioned average major axis and average thickness are readily available.

In addition, according to the findings of the inventors of the present invention, because indium and/or chromium is less likely to interact with curable components in inkjet inks and is thus less likely to induce a curing reaction as compared to conventional general-purpose aluminum pigments, the storage stability of inks before use is easily improved.

Furthermore, since indium and/or chromium do not particularly inhibit the curing reaction of inkjet inks, the compatibility between ink curability (curing speed) and storage stability before use is easily achieved.

In addition, because indium and chromium are less likely to undergo chemical changes (oxidation, corrosion, and the like) in inkjet inks or cured products thereof as compared to conventional aluminum pigments and the like, the metallic gloss of a provided image is easily maintained.

From the viewpoint of lustrousness, at least some of the scale-like metal particles are usually a metal simple substance and is not a compound such as an oxide, a nitride or a hydroxide. For example, the above-mentioned indium and/or chromium are preferably metallic indium and/or metallic chromium. However, this does not mean that the scale-like metal particles do not at all include compounds such as oxides, nitrides, and hydroxides. Some (but not all) of the scale-like metal particles may be oxides, nitrides, hydroxides, and the like as long as they have lustrousness and/or metallic gloss. Furthermore, the scale-like metal particles may be an alloy.

The average particle diameter of the scale-like metal particles determined by a light scattering method is not particularly limited. It is appropriately selected in consideration of a desired level of metallic gloss, ease of ink jetting, and the like.

The Z-average particle diameter of the scale-like metal particles is preferably 50 to 500 nm and more preferably 100 to 400 nm. By setting the Z-average particle diameter to a somewhat large diameter, the level of metallic gloss of a final image can be further increased. In addition, be setting the Z-average particle diameter to a diameter that is not too large, the inkjet ink tends to be jetted from a head more smoothly. It is also thought that clogging of a head can be prevented.

The Z-average particle diameter of the scale-like metal particles can be measured by a light scattering method based on the standards of ISO 22142:2017. More specifically, the harmonic average particle diameter weighted by an intensity of scattered light based on a cumulant method can be employed as the Z-average particle diameter.

Examples of measurement devices capable of measuring by the light scattering method include Zetasizer Nano ZS manufactured by Malvern Panalytical Ltd. Measurement is usually performed by wet type. In other words, a measurement sample obtained by dispersing the scale-like metal particles in a solvent can be used.

The scale-like metal particles may be surface-modified by a physical/chemical treatment. For example, modification may be expected to prevent the oxidation of the metal so that metallic gloss is less likely to be lost. Furthermore/alternatively, modification can cause the scale-like metal particles to be unevenly distributed on the upper part of a cured film, which makes it possible to further increase the level of metallic gloss.

As one aspect, the scale-like metal particles are preferably surface-modified with a group including a linear or branched alkyl group having 4 or more carbon atoms (specifically, 4 to 230 carbon atoms), or a silicon atom-containing group or a fluorine atom-containing group (which are collectively referred to as “specific functional groups”). In an uncured stage after jetting the inkjet ink onto a base material surface, when at least any of the specific functional groups is present on the surfaces of the scale-like metal particles, this prevents the sedimentation of the scale-like metal particles (which can be explained by theories such as thermodynamics and surface energy). Due to that, the level of metallic gloss of a final image can be further increased.

In particular, when using scale-like metal particles having a large specific gravity (when using indium particles or chromium particles, for example), the scale-like metal particles are surface-modified to prevent the sedimentation of the scale-like metal particles, which makes it possible to increase the level of metallic gloss of a final image.

More specifically, the scale-like metal particles are preferably surface-modified with a group having a structure represented by General Formula (1).

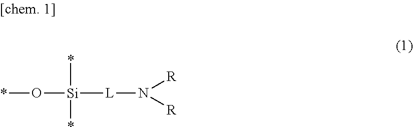

In General Formula (1),

two R's are each independently a hydrogen atom, a monovalent organic group, or a group represented by General Formula (2), provided that at least one of the two R's is the group represented by General Formula (2);

L is a divalent linking group; and

* is a bonding site with other chemical structures.

[chem. 2]

*—CH₂—CHR²—COOR¹ (2)

In General Formula (2),

R¹ is a group including a linear or branched alkyl group having 4 or more carbon atoms, a silicon atom-containing group, or a fluorine atom-containing group; and

R² is a hydrogen atom or a methyl group.

In General Formula (1), when R is not the group represented by General Formula (2), R is a hydrogen atom or a monovalent organic group. Examples of the monovalent organic groups herein include an alkyl group, a cycloalkyl group, an alkoxy group, an aryl group, an aralkyl group, an alkylcarbonyl group, an alkoxycarbonyl group, and an alkylcarbonyloxy group.

The number of carbon atoms in the monovalent organic group is not particularly limited. For example, the number of carbon atoms is 1 to 20, specifically 1 to 10.

From the viewpoint of further preventing the sedimentation of the scale-like metal particles, R is preferably a group including a linear or branched alkyl group having 4 or more carbon atoms, and is more preferably a linear or branched alkyl group having 4 or more carbon atoms.

From the viewpoint of further preventing the sedimentation of the scale-like metal particles, both of the two R′ s in General Formula (1) are preferably the group represented by General Formula (2).

Examples of the divalent linking group as L in General Formula (1) include an alkylene group (which may be linear or branched), an alicyclic group (which may be monocyclic or polycyclic), an aromatic group, an ether group, an ester group, a thioether group, a sulfide group, a carbonyl group, an amide group (—CONH—), a —NH— group, and groups in which two or more of these are linked.

The number of carbon atoms of L as a whole is not particularly limited. For example, when L is an alkylene group, the preferable number of carbon atoms is 1 to 12, and the more preferable number of carbon atoms is 1 to 6. When L is an alicyclic group, the preferable number of carbon atoms is 3 to 12. When L is an aromatic group, the preferable number of carbon atoms is 6 to 20.

L is preferably (i) an alkylene group, or is preferably a group in which (ii) at least one group selected from the group consisting of an ether group, an ester group, a thioether group, a sulfide group, a carbonyl group, a —NH— group, and an amide group (—CONH—) is linked to an alkylene group.

Examples of the alkyl group when R¹ is a linear or branched alkyl group having 4 or more carbon atoms in General Formula (2) include an n-butyl group, an isobutyl group, a pentyl group, a neopentyl group, an isopentyl group, a hexyl group, a heptyl group, an octyl group, a nonyl group, a decyl group, an undecyl group, a dodecyl group, a tridecyl group, a tetradecyl group, a pentadecyl group, a hexadecyl group, a heptadecyl group, an octadecyl group, a nonadecyl group, an eicosyl group, an isolauryl group, an isostearyl group, an isocetyl group, an octyldodecyl group, a myristyl group, a 2-ethylhexyl group, a 2-hexyldecyl group, a 2-decyl myristyl group, a 2,7-dimethylhexadecyl group, an isotridecyl group, a 2,2-dimethyllauryl group, a 2,3-dimethyllauryl group, a 2,2-dimethylstearyl group, and a 2,3-dimethylstearyl group. Needless to say, the alkyl groups are not limited to these examples.

From the viewpoint of availability of materials, ease of manufacture, and the like, R¹ is preferably a linear or branched alkyl group having 4 or more carbon atoms (provided that R¹ is not a group including the following alkyl group as a partial structure, but R¹ itself as a whole is the following alkyl group).

When R¹ is a silicon atom-containing group in General Formula (2), examples of R¹ include a group including an alkylsilyl group, a group having a polysiloxane structure, a group having a cyclic siloxane structure, and a group having a silsesquioxane (ladder type, cage type) structure.

Among these, a group including an alkylsilyl group or a group including a polysiloxane structure is preferable from the viewpoint of availability of raw materials. Herein, more specifically, preferable examples of the polysiloxane structure include a polydialkylsiloxane structure such as a polydimethylsiloxane structure (—Si(CH₃)₂—O—), and a polydiphenylsiloxane structure (—Si(C₆H₅)₂—O—).

Specific examples of the fluorine atom-containing group as R¹ in General Formula (2) include a fluorine-substituted alkyl group, a fluorine-substituted cycloalkyl group, a fluorine-substituted alkoxy group, a fluorine-substituted aryl group, a fluorine-substituted aralkyl group, a fluorine-substituted alkylcarbonyl group, a fluorine-substituted alkoxycarbonyl group, and a fluorine-substituted alkylcarbonyloxy group.

The fluorine atom-containing group as R¹ may be one (perfluoro group) in which all of the hydrogen atoms are substituted with fluorine atoms, or may be one in which only some of the hydrogen atoms are substituted with fluorine atoms. From the viewpoint of further preventing the sedimentation of the scale-like metal particles, it is preferable that equal to or more than 50 mol % of the hydrogen atoms in the fluorine atom-containing group as R¹ be substituted with fluorine atoms.

R¹ is preferably a group including a branched alkyl group or a group having a polydimethylsiloxane structure from the viewpoint of the sedimentation being less likely to be caused, compatibility with other components when preparing the inkjet ink, and the like.

A method for surface-modifying the scale-like metal particles is not particularly limited. For example, when surface-modifying with the group represented by General Formula (1), a method such as the following first and second steps can be employed.

### First Step

First, scale-like metal particles as a raw material (referred to as “raw material particle” in the following chemical formula) is reacted with a silane coupling agent represented by General Formula (1a) to introduce —NH₂ structure into the surfaces of the scale-like metal particles. Specific examples of the silane coupling agent include aminosilanes listed in the section of “Further other components” to be described later.

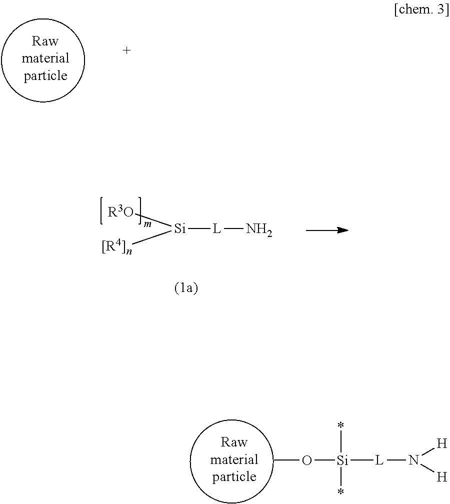

In General Formula (1a),

R³'s are each independently an alkyl group or an acyl group when there are a plurality of R³'s;

R⁴'s are each independently an alkyl group when there are a plurality of R⁴'s;

m is an integer of 1 to 3, n is an integer of 0 to 2, and m+n is 3; and

L is a divalent linking group.

The number of carbon atoms of R³ is preferably 1 to 10, and more preferably 1 to 4.

Specific examples of R³ include an alkyl group such as a methyl group, an ethyl group, an n-propyl group, an isopropyl group, an n-butyl group, an isobutyl group, a sec-butyl group, a tert-butyl group, a pentyl group, a neopentyl group, a hexyl group, a heptyl group, an octyl group, a nonyl group, and a decyl group; and an acyl group represented by —CO—R′ (provided that R′ is any of the alkyl groups listed herein, for example).

R³ is preferably a methyl group or an ethyl group, and is particularly preferably a methyl group.

The number of carbon atoms of R⁴ is preferably 1 to 10, and more preferably 1 to 4.

Specific examples of R⁴ include the alkyl groups listed as the specific examples of R³.

R⁴ is preferably a methyl group or an ethyl group, and is particularly preferably a methyl group.

m is preferably 2 or 3, and is more preferably 3.

n is preferably 0 or 1, and is more preferably 0.

Specific examples of the divalent linking group as L are the same as those as L in General Formula (1).

### Second Step

A compound having a specific functional group is bonded to the —NH₂ introduced into the surfaces of the scale-like metal particles as a raw material. More specifically, Michael addition of a compound represented by General Formula (2a) to the —NH₂ introduced into the surfaces of the raw material particles is caused. Thus, the carbon-carbon double bond portion of the compound represented by General Formula (2a) reacts with the —NH₂ to be bonded thereto.

[chem. 4]

CH₂═CHR²—COOR¹ (2a)

The definitions and specific examples of R¹ and R² in General Formula (2a) are the same as those of General Formula (2).

In the second step, the amount of the compound represented by General Formula (2a) adjusted, which makes it possible to obtain the scale-like metal particles in which one or both of R's in General Formula (1) are surface-modified with the group represented by General Formula (2). In principle, equal to or more than 2 mol of the compound represented by General Formula (2a) is reacted with 1 mol of —NH₂, which makes it possible to obtain filler particles in which both R's in General Formula (1) are the group represented by General Formula (2).

In the above description, the scale-like metal particles as a raw material is reacted with the silane coupling agent represented by General Formula (1a) in the first step to cause Michael addition of the compound represented by General Formula (2a) in the second step.

Aside from such a procedure, the scale-like metal particles may be surface-modified by (i) first, reacting the silane coupling agent represented by General Formula (1a) with the compound represented by General Formula (2a), and (ii) subsequently, reacting the reaction product obtained in i) with the scale-like metal particles as a raw material.

As a supplementary explanation for the sake of precaution, although the surface modification of the scale-like metal particles has been described above, the scale-like metal particles that are not surface-modified may be used in the inkjet ink of the present embodiment. The use of the scale-like metal particles that are not surface-modified leads to a reduction in manufacturing costs, and the like.

The scale-like metal particles (which are not surface-modified with specific functional groups) can be obtained from OIKE & Co., Ltd., for example. In addition, regarding a method for manufacturing the scale-like metal particles, Japanese Laid-open Patent Publication No. H11-323223, Japanese Laid-open Patent Publication No. H11-343436, Japanese Laid-open Patent Publication No. 2011-52041, and the like can be referred to.

The inkjet ink of the present embodiment may contain only one type of the scale-like metal particles, or may contain two or more types of the scale-like metal particles.

In addition, the inkjet ink of the present embodiment may contain, for example, a pigment different from the scale-like metal particles (such as non-scale-like metal particles) within a range not excessively impairing the performance. Needless to say, the inkjet ink of the present embodiment may not contain such a pigment.

The ratio of the scale-like metal particles in the inkjet ink of the present embodiment maybe 2 to 10 mass % and is more preferably 2 to 6 mass % in the total amount of the inkjet ink. When this ratio is equal to or more than 2 mass %, a sufficient level of metallic gloss can be obtained in a final printed material. Furthermore, when this ratio is equal to or less than 10 mass %, a sufficient amount of other components (curable components) can be incorporated in the inkjet ink. This is preferable from the viewpoint of reducing head clogging, improving the durability of a final printed material, and the like.

### Regarding Polymerization Mode of Inkjet Ink, and Curable Component

The inkjet ink of the present embodiment is typically photocurable or thermosetting, but is preferably photocurable.

A polymerization mode of the inkjet ink is not particularly limited. The polymerization mode is preferably a cationic polymerization type or a radical polymerization type. In other words, specifically, the inkjet ink of the present embodiment may be (i) an inkjet ink containing a cationically polymerizable compound and a cationic polymerization initiator in addition to the scale-like metal particles, or maybe (ii) an inkjet ink containing a radically polymerizable compound and a radical polymerization initiator in addition to the scale-like metal particles.

Hereinbelow, the cationically polymerizable compound and the cationic polymerization initiator in (i), and the radically polymerizable compound and the radical polymerization initiator in (ii) will be described.

First, the cationically polymerizable compound and the cationic polymerization initiator in (i) mentioned above will be described.

### Cationically Polymerizable Compound

Typical examples of the cationically polymerizable compound include an oxetane compound, an epoxy compound, a vinyl ether compound, and the like. Two or more types of these may be used in combination. For example, a cationically polymerizable-type ink may contain both an oxetane compound and an epoxy compound. By using two or more different types of cationically polymerizable compounds in combination, compatibility between curability and storage stability can be achieved at a higher level.

In the present embodiment, it is particularly preferable that the cationically polymerizable compound include a compound having an epoxy group and/or an oxetanyl group.

Examples of the epoxy compound include aromatic epoxides, alicyclic epoxides, aliphatic epoxides, and the like. As the aromatic epoxide, a polyhydric phenol having at least one aromatic ring or its alkylene oxide adduct, or di- or poly-glycidyl ether obtained by reaction with epichlorohydrin is used. Examples thereof include di- or poly-glycidyl ether of bisphenol A or its alkylene oxide adduct, di- or poly-glycidyl ether of hydrogenated bisphenol A or its alkylene oxide adduct, a novolac type epoxy resin, and the like. Examples of alkylene oxides include ethylene oxide, propylene oxide, and the like.

As the epoxy compound, a compound having two or more epoxy groups in one molecule is preferable, and a compound having 2 to 6 epoxy groups in one molecule is more preferable.

As the alicyclic epoxide, a cyclohexene oxide- or cyclopentene oxide-containing compound obtained by epoxidizing a compound having at least one cycloalkane ring such as a cyclohexene ring or a cyclopentene ring with an oxidizing agent such as hydrogen peroxide or a peracid is used.

As the aliphatic epoxide, di- or poly-glycidyl ether of an aliphatic polyhydric alcohol or its alkylene oxide adduct is used. Examples thereof include diglycidyl ether of alkylene glycol, such as diglycidyl ether of ethylene glycol, diglycidyl ether of propylene glycol, and diglycidyl ether of 1,6-hexanediol; polyglycidyl ethers of polyhydric alcohols such as di- or tri-glycidyl ethers of glycerin or its alkylene adduct; diglycidyl ether of polyalkylene glycol, such as diglycidyl ether of polyethylene glycol or its alkylene oxide adduct, and diglycidyl ether of polypropylene glycol or its alkylene oxide adduct; and the like. Examples of alkylene oxides include ethylene oxide, propylene oxide, and the like.

Among these epoxides, from the viewpoint of curability, aromatic epoxides or alicyclic epoxides are preferable, and alicyclic epoxides are more preferable.

Regarding the epoxy compound, one type or two or more types thereof can be selected suitably and used.

The oxetane compound is preferably a compound having 1 to 4 oxetanyl groups in one molecule, and is more preferably a compound having 2 to 4 oxetanyl groups in one molecule.

Specific examples of the oxetane compound include 3-ethyl-3-[[(3-ethyloxetane-3-yl)methoxy]methyl]oxetane, 3-ethyl-3-hydroxymethyloxetane, 4,4′-bis[(3-ethyl-3-oxetanyl)methoxymethyl]biphenyl, 3-(meth)allyloxymethyl-3-ethyloxetane, (3-ethyl-3-oxetanylmethoxy)methylbenzene, (3-ethyl-3-oxetanylmethoxy)benzene, 4-fluoro-[1-(3-ethyl-3-oxetanylmethoxy)methyl]benzene, 4-methoxy-[1-(3-ethyl-3-oxetanylmethoxy)methyl]benzene, [1-(3-ethyl-3-oxetanylmethoxy)ethyl]phenyl ether, isobutoxymethyl(3-ethyl-3-oxetanylmethyl)ether, isobornyloxyethyl-(3-ethyl-3-oxetanylmethyl)ether, isobornyl(3-ethyl-3-oxetanylmethyl)ether, 2-ethylhexyl(3-ethyl-3-oxetanylmethyl)ether, ethyldiethylene glycol(3-ethyl-3-oxetanylmethyl)ether, dicyclopentadiene-(3-ethyl-3-oxetanylmethyl)ether, dicyclopentenyloxyethyl(3-ethyl-3-oxetanylmethyl)ether, dicyclopentyl(3-ethyl-3-oxetanylmethyl)ether, tetrahydrofurfuryl-(3-ethyl-3-oxetanylmethyl)ether, tetrabromophenyl(3-ethyl-3-oxetanylmethyl)ether, 2-tetrabromophenoxyethyl-(3-ethyl-3-oxetanylmethyl)ether, tribromophenyl(3-ethyl-3-oxetanylmethyl)ether, 2-tribromophenoxyethyl(3-ethyl-3-oxetanylmethyl)ether, butoxyethyl(3-ethyl-3-oxetanylmethyl)ether, pentachlorophenyl-(3-ethyl-3-oxetanylmethyl)ether, pentabromophenyl(3-ethyl-3-oxetanylmethyl)ether, bornyl-(3-ethyl-3-oxetanylmethyl)ether, 3,7-bis(3-oxetanyl)-5-oxanonan, 3,3′-[1,3-(2-methyrenyl)-propanediyl bis(oxymethylene)]-bis(3-ethyloxetane), 1,4-bis[(3-ethyl-3-oxetanylmethoxy) methyl]benzene, 1,2-bis[(3-ethyl-3-oxetanylmethoxy)methyl]ethane, 1,3-bis[(3-ethyl-3-oxetanylmethoxy)methyl]propane, ethylene glycol bis(3-ethyl-3-)oxetanylmethyl)ether, dicyclopentenyl bis(3-ethyl-3-oxetanylmethyl)ether, triethylene glycol bis(3-ethyl-3-oxetanylmethyl)ether, tetraethylene glycol bis(3-ethyl-3-oxetanylmethyl)ether, tricyclodecandyldimethylene-(3-ethyl-3-oxetanylmethyl)ether, trimethylolpropane tris(3-ethyl-3-oxetanylmethyl)ether, 1,4-bis(3-ethyl-3-oxetanylmethoxy)butane, 1,6-bis(3-ethyl-3-oxetanylmethoxy)hexane, pentaerythritol tris(3-ethyl-3-oxetanylmethyl)ether, pentaerythritol tetrakis(3-ethyl-3-oxetanylmethyl)ether, polyethylene glycol bis(3-ethyl-3-oxetanylmethyl)ether, dipentaerythritol hexakis(3-ethyl-3-oxetanylmethyl)ether, dipentaerythritol pentakis(3-ethyl-3-oxetanylmethyl)ether, dipentaerythritol tetrakis(3-ethyl-3-oxetanylmethyl)ether, caprolactone-modified dipentaerythritol hexakis(3-ethyl-3-oxetanylmethyl)ether, caprolactone-modified dipentaerythritol pentakis(3-ethyl-3-oxetanylmethyl)ether, ditrimethylolpropane tetrakis(3-ethyl-3-oxetanylmethyl)ether, ethylene oxide-modified bisphenol A-bis(3-ethyl-3-oxetanylmethyl)ether, propylene oxide-modified bisphenol A-bis(3-ethyl-3-oxetanylmethyl)ether, ethylene oxide-modified hydrogenated bisphenol A-bis(3-ethyl-3-oxetanylmethyl)ether, propylene oxide-modified hydrogenated bisphenol A-bis(3-ethyl-3-oxetanylmethyl)ether, ethylene oxide-modified bisphenol F-(3-ethyl-3-oxetanylmethyl)ether, and the like.

Regarding the oxetane compound, one type or two or more types thereof can be appropriately selected and used.

The vinyl ether compound is preferably a di- or tri-vinyl ether compound, and is more preferably a divinyl ether compound, from the viewpoint of curability and adhesiveness.

Examples of the vinyl ether compound include di- or tri-vinyl ether compounds such as ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexanedimethanol divinyl ether, and trimethylolpropane trivinyl ether.

Examples thereof further include monovinyl ether compounds such as ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexanedimethanol monovinyl ether, n-propyl vinyl ether, isopropyl vinyl ether, isopropenyl ether-o-propylene carbonate, dodecyl vinyl ether, diethylene glycol monovinyl ether, and octadecyl vinyl ether.

Regarding the vinyl ether compound, one type or two or more types thereof can be appropriately selected and used.

As the cationically polymerizable compound, it is more preferable to use an oxetane compound and an epoxy compound (especially an alicyclic epoxide) in combination. According to the findings of the inventors of the present invention, such combined use can make, particularly the curability of the inkjet ink, favorable. In addition, the level of metallic gloss of a provided image tends to become higher than when an epoxy compound is used alone.

When an oxetane compound and an epoxy compound are used in combination, the ratio (mass %) of the epoxy compound, that is, {amount of epoxy compound/(amount of oxetane compound+amount of epoxy compound)}×100 is preferably 15 to 85 mass %, and is more preferably 20 to 80 mass %. When the proportion of the epoxy compound is somewhat large, better curability is easily obtained. In addition, when the proportion of the epoxy compound is not too large, storage stability tends to become better (meaning an increase in viscosity is easily prevented).

When the inkjet ink of the present embodiment contains the cationically polymerizable compound, the amount thereof is not particularly limited. The amount thereof is usually 70 to 99.9 mass %, preferably 85 to 99.5 mass %, and more preferably 90 to 99 mass % when the total amount of nonvolatile components (components other than a volatile organic solvent) in the ink is taken as 100 mass %.

### Cationic Polymerization Initiator

As the cationic polymerization initiator, any photocationic polymerization initiator can be used as long as it can generate a cation by an external stimulus such as irradiation with light and polymerize the above-mentioned cationically polymerizable compound. For example, known photocationic polymerization initiators such as onium salts, and more specifically sulfonium salt derivatives and iodonium salt derivatives can be used.

More specific examples of the cationic polymerization initiator include diazonium salts, iodonium salts, sulfonium salts, and the like. These are onium salts in which cationic moieties are respectively aromatic diazonium, aromatic iodonium, and aromatic sulfonium, and an anionic moiety is composed of BF₄⁻, PF₆⁻, [BX₄]⁻ (provided that X is a phenyl group substituted with at least two or more fluorine or trifluoromethyl groups), (Rf)ₙPF₆₋ₙ, (provided that Rf is a fluorine-containing group such as a fluorinated alkyl group, and n is an integer of 0=6), or the like.

Specific compounds include phenyldiazonium salts of boron tetrafluoride, diphenyliodonium salts of phosphorus hexafluoride, diphenyliodonium salts of antimony hexafluoride, tri-4-methylphenylsulfonium salts of arsenic hexafluoride, tri-4-methylphenylsulfonium salts of antimony tetrafluoride, diphenyliodonium salts of boron tetrakis(pentafluorophenyl), a mixture of acetylacetone aluminum salt and orthonitrobenzyl silyl ether, phenylthiopyridium salts, a phosphorene hexafluoride-iron complex, and the like.

Examples of commercially available products of the cationic polymerization initiator include photocationic polymerization initiators such as CPI-100P, CPI-101A, and CPI-200K (manufactured by San-Apro Ltd.), and WPI-113 and WPI-124 (manufactured by FUJIFILM Wako Pure Chemical Corporation).

The inkjet ink of the present embodiment may contain only one type of the cationic polymerization initiator, or may contain two or more types thereof.

The amount of the cationic polymerization initiator in the inkjet ink of the present embodiment is not particularly limited. The amount thereof is usually 0.5 to 15 parts by mass, preferably 1.0 to 10 parts by mass, more preferably 2 to 8 parts by mass, and particularly preferably 3 to 6 parts by mass with respect to 100 parts by mass of the cationicallypolymerizable compound. By appropriately adjusting the amount of the cationic polymerization initiator, compatibility between storage stability and curability can be achieved at a higher level.

Next, the radically polymerizable compound and the radical polymerization initiator in (ii) mentioned above will be described.

### Radically Polymerizable Compound

Examples of the radically polymerizable compound include compounds (radically polymerizable monomers) having one or two or more polymerizable carbon-carbon double bonds in one molecule. The radically polymerizable compound is preferably a compound having one or two or more (meth)acryloyl groups in one molecule.

Examples of monofunctional monomers (compounds having only one polymerizable carbon-carbon double bond in one molecule) include methyl (meth)acrylate, ethyl (meth)acrylate, n-butyl (meth)acrylate, isobutyl (meth)acrylate, tert-butyl (meth)acrylate, 2-ethylhexyl (meth)acrylate, isodecyl (meth)acrylate, n-lauryl (meth)acrylate, n-stearyl (meth)acrylate, phenyl (meth)acrylate, benzyl (meth)acrylate, isobornyl (meth)acrylate, dimethyl (meth) acrylamide, diethyl (meth) acrylamide, di-n-propyl (meth)acrylamide, dibutyl (meth)acrylamide, and the like.

Examples of polyfunctional monomers (compounds having two or more, preferably 2 to 6 polymerizable carbon-carbon double bonds in one molecule) include bifunctional monomers such as triethylene glycol di(meth)acrylate, tetraethylene glycol di(meth)acrylate, polyethylene glycol di(meth)acrylate, tripropylene glycol di(meth)acrylate, polypropylene glycol di(meth)acrylate, 1,4-butanediol di(meth)acrylate, 1,6-hexanediol di(meth)acrylate, 1,9-nonanedioldi(meth)acrylate, neopentyl glycol di(meth)acrylate, dimethylol-tricyclodecane di(meth)acrylate, a PO adduct di(meth)acrylate of bisphenol A, neopentyl glycol di(meth)acrylate of hydroxypivalate, polytetramethylene glycol di (meth) acrylate, and the like.

Examples of polyfunctional monomers further include trimethylolpropane tri(meth)acrylate, pentaerythritol tri(meth)acrylate, EO-modified trimethylolpropane tri(meth)acrylate, pentaerythritol tetra(meth)acrylate, EO-modified pentaerythritol tetra (meth) acrylate, dipentaerythritol hexa(meth)acrylate, ditrimethylolpropane tetra(meth)acrylate, glycerin propoxy tri(meth)acrylate, caprolactone-modified trimethylolpropane tri(meth)acrylate, pentaerythritol ethoxy tetra(meth)acrylate, caprolactam-modified dipentaerythritol hexa(meth)acrylate, and the like.

A monomer having a polar group (for example, a phosphoric acid group or a carboxy group) maybe used as the radically polymerizable monomer from the viewpoint other than the viewpoint of the number of polymerizable functional groups.

Examples of monomers having a phosphoric acid group include 2-(meth)acryloyloxyethyl acid phosphate, di(2-methacryloyloxyethyl) acid phosphate, caprolactone modified-2-acryloyloxyethyl acid phosphate, diphenyl-2-acryloyloxyethyl phosphate, and the like.

Examples of monomers having a carboxy group include (meth)acrylic acid, crotonic acid, itaconic acid, maleic acid, fumaric acid, citraconic acid, 2-(meth)acryloyloxymethylsuccinic acid, 2-(meth)acryloyloxyethyl succinic acid, and the like.

The inkjet ink may contain only one type of the radically polymerizable monomer, or may contain two or more types thereof. From the viewpoints of appropriate polymerizability, crosslink density, and adhesiveness, it is preferable to use, for example, a monofunctional monomer and a polyfunctional monomer in combination. Furthermore, from the viewpoint of adjusting adhesiveness and dispersibility of the ink, it is preferable to use a monomer having a polar group and a monomer that does not have a polar group in combination.

When the inkjet ink of the present embodiment contains the radically polymerizable monomer, the amount thereof is not particularly limited. The amount thereof is usually 85 to 99.5 mass % and is preferably 90 to 99 mass % when the total amount of nonvolatile components (components other than a volatile organic solvent) in the ink is taken as 100 mass %.

### Radical Polymerization Initiator

The radical polymerization initiator is not particularly limited as long as it can generate radicals by an external stimulus such as irradiation with light and polymerize the above-mentioned radically polymerizable monomer.

Specific examples of the radical polymerization initiator include α-hydroxyketone photoinitiators, α-aminoketone photoinitiators, bisacylphosphine photoinitiators, monoacylphosphine oxides, bisacylphosphine oxides such as 2,4,6-trimethylbenzoylbiphenylphosphine oxides, ethyl-2,4,6-trimethylbenzoylphenylphosphinate, mono- and bis-acylphosphine photoinitiators, benzyldimethyl-ketal photoinitiators, oligo[2-hydroxy-2-methyl-1-[4-(1-methylvinyl)phenyl]propanone], and the like.

Examples of commercially available products of the radical polymerization initiator include photoradical polymerization initiators such as IRGACURE (registered trademark) series manufactured by BASF. Needless to say, radical polymerization initiators other than these can also be used.

The inkjet ink of the present embodiment may contain only one type of the radical polymerization initiator, or may contain two or more types thereof.

The amount of the radical polymerization initiator in the inkjet of the present embodiment is not particularly limited. The amount thereof is usually 0.5 to 15 parts by mass and is preferably 1.0 to 10 parts by mass with respect to 100 parts by mass of the radically polymerizable monomer.

### Further Other Components

The inkjet ink of the present embodiment may contain optional components in addition to the above-mentioned components. Examples of the optional components include dispersants, defoamers, leveling agents, polymerization inhibitors, waxes, antioxidants, non-reactive polymers, fine particle inorganic fillers, silane coupling agents, light stabilizers, ultraviolet absorbers, antistatic agents, slip agents, storage stabilizers, solvents (typically organic solvents), and the like. The inkjet ink of the present embodiment can contain one type or two or more types thereof.

The inkjet ink of the present embodiment preferably contains a silane coupling agent from the viewpoint of improving adhesiveness. It is particularly preferable to use a silane coupling agent when the inkjet ink of the present embodiment is a cationically polymerizable-type.

Examples of the silane coupling agent include aminosilane, epoxysilane, (meth)acrylsilane, mercaptosilane, vinylsilane, ureidosilane, sulfidesilane, and the like. In particular, epoxysilane (a compound having an epoxy group and a hydrolyzable silyl group) is preferable from the viewpoint of improving adhesiveness and compatibility with the above-described cationically polymerizable compound.

Examples of aminosilanes include
bis(2-hydroxyethyl)-3-aminopropyltriethoxysilane, γ-aminopropyltriethoxysilane, γ-aminopropyltrimethoxysilane, γ-aminopropylmethyldiethoxysilane, γ-aminopropylmethyldimethoxysilane, N-β(aminoethyl) γ-aminopropyltrimethoxysilane, N-β(aminoethyl) γ-aminopropyltriethoxysilane, N-β(aminoethyl) γ-aminopropylmethyldimethoxysilane, N-β(aminoethyl) γ-aminopropylmethyldiethoxysilane, N-phenyl-γ-amino-propyltrimethoxysilane, and the like.

Examples of epoxysilanes include
γ-glycidoxypropyltrimethoxysilane, γ-glycidoxypropylmethyldiethoxysilane, β-(3,4-epoxycyclohexyl)ethyltrimethoxysilane, γ-glycidylpropyltrimethoxysilane, and the like.

Examples of acrylsilanes include
γ-(methacryloxypropyl)trimethoxysilane, γ-(methacryloxypropyl)methyldimethoxysilane, γ-(methacryloxypropyl)methyldiethoxysilane, and the like.

Examples of mercaptosilanes include
3-mercaptopropyltrimethoxysilane and the like.

Examples of vinylsilanes include
vinyltris (β-methoxyethoxy)silane, vinyltriethoxysilane, vinyltrimethoxysilane, and the like.

Examples of ureidosilanes include
3-ureidopropyltriethoxysilane and the like.

Examples of sulfidesilanes include
bis(3-(triethoxysilyl)propyl)disulfide, bis(3-(triethoxysilyl)propyl)tetrasulfide, and the like.

When the inkjet ink of the present embodiment contains the silane coupling agent, the inkjet ink may contain only one type or two or more types thereof.

When the inkjet ink of the present embodiment contains a dispersant, the amount thereof is usually 0.1 to 30 mass % and is preferably 1 to 20 mass % when the total amount of nonvolatile components (components other than a volatile organic solvent) in the ink is taken as 100 mass %.

The inkjet ink of the present embodiment preferably contains a dispersant.

From the viewpoint of further improving the dispersibility of the scale-like metal particles, one method is to subject the scale-like metal particles to surface modification as described above, but the dispersibility of the scale-like metal particles can also be improved by using a dispersant together with the surface modification/separately from the surface modification. There are various types of dispersants such as those containing acid groups, those containing amine structures, and those containing other polar groups. In addition, there are low-molecular-weight type dispersants and high-molecular-weight type dispersants. In the present embodiment, any dispersant can be used as long as it does not excessively impair the curability and storage stability of the inkjet ink.

As the findings of the inventors of the present invention, a dispersant containing an acid group is preferably used as the dispersant. Although the details are unknown, it is thought that an acid group interacts well with the surfaces of the scale-like metal particles. In addition, from another viewpoint, a high-molecular-weight type dispersant is preferably used as the dispersant.

As the dispersant, a commercially available product can be used. Examples of commercially available dispersants include “DISPERBYK” series and “CERATIX” series of BYK Additives & Instruments, “DISPERS” series of TEGO, and “Solsperse” series of The Lubrizol Corporation.

When the inkjet ink of the present embodiment contains the dispersant, the inkjet ink may contain only one type of the dispersant, or may contain two or more types of the dispersants.

When the inkjet ink of the present embodiment contains a dispersant, the amount thereof is usually 0.01 to 4 mass % and is preferably 0.01 to 2 mass % when the total amount of nonvolatile components (components other than a volatile organic solvent) in the ink is taken as 100 mass %.

The inkjet ink of the present embodiment preferably contains a storage stabilizer.

Examples of the storage stabilizer include amine compounds such as triethanolamine, triisopropanolamine, p-dimethylaminobenzoic acid ethyl ester, p-formyldimethylaniline, and p-methylthiodimethylaniline; thiol compounds, such as 2-mercaptobenzothiazole, 2-mercaptobenzoxazole, 2-mercaptobenzimidazole, 2-mercapto-4(3H)-quinazoline, and β-mercaptonaphthalene, and their sulfide compounds or disulfide compounds; amino acid compounds such as N-phenylglycine; organometallic compounds such as tributyl tin acetate; hydrogen donors; sulfur compounds such as trithiane; and phosphorus compounds such as diethyl phosphite.

When the storage stabilizer is used, only one type maybe used, or two or more types may be used in combination.

When the storage stabilizer is used, the amount thereof is 0.03 to 0.15 mass % and is preferably 0.05 to 0.12 mass %, for example, in the total amount of nonvolatile components of the inkjet ink.

The inkjet ink of the present embodiment may or may not contain a solvent as long as the inkjet ink has a viscosity/fluidity that enables it to be jetted from an inkjet head. Even when the solvent is not intentionally used, the solvent maybe contained in the inkjet ink when the scale-like metal particles as the raw material are in the form of a dispersion liquid, for example.

The inkjet ink of the present embodiment usually does not contain the solvent, but even when the inkjet ink contains the solvent, the amount thereof is equal to or less than 50 mass %, preferably equal to or less than 25 mass %, and more preferably equal to or less than 15 mass %, for example, with respect to the total amount of the ink. The inkjet ink of the present embodiment may contain, for example, equal to or more than 5 mass % of the solvent with respect to the total amount of the ink from another viewpoint of the introduction of the solvent from the raw material (dispersion liquid of the scale-like metal particles, and the like) of the inkjet ink.

The inkjet ink of the present embodiment is preferably an inkjet ink in which there are substantially no volatilization of a solvent or the like and soaking of the ink into a base material at a stage when the ink is fixed to the base material.

The viscosity of the inkjet ink of the present embodiment depends on an inkjet head used, but is preferably 2 to 50 mPa·s and is more preferably 8 to 25 mPa·s from the viewpoint of suitable jettability.

### Method for Manufacturing Inkjet Ink

The inkjet ink of the present embodiment can be obtained by thoroughly mixing each of the above-mentioned components. For mixing, methods and devices known in the field of ink can be used as appropriate.

### Method for Manufacturing Printed Material, and Printed Material

A printed material (printed material containing a cured product of the inkjet ink) can be manufactured by the following series of steps including:

an image forming step of jetting the inkjet ink of the present embodiment onto a surface of a base material to form an image; and

a curing step of curing the jetted inkjet ink.

A portion of the cured product of the inkjet ink in this printed material has metallic gloss.

The image forming step can be performed using a known inkjet device (inkjet printer). That is, an image may be formed on the surface of the base material by jetting liquid droplets of the inkjet ink onto the surface of the base material using a device having an inkjet head capable of jetting the inkjet ink as fine liquid droplets.

The inkjet head preferably employs a piezo system from the viewpoint of preventing a deterioration of the ink. Examples of commercially available products of the inkjet head include KM1024 series manufactured by Konica Minolta, Inc.

In the image forming step, the volume of the liquid droplets jetted from the inkjet head is not particularly limited. The volume of the liquid droplets is typically about 2 to 50 pL.

In the image forming step, the density of the liquid droplets jetted from the inkjet head is not particularly limited. The density of the liquid droplets may be appropriately determined in consideration of the specifications of an inkjet device, the design of a final printed material, and the like.

A method of moving the inkjet head in the image forming step is not particularly limited. Any method in general inkjet printing, such as a single-pass method, a multi-pass method, and a scan method, can be employed.

The base material (base material onto which the inkjet ink is jetted) in the image forming step is not particularly limited. The material of the base material can be paper, wood, metal, glass, resin, rubber, stone, concrete, or the like, for example. The base material is not limited to examples other than these as long as the inkjet ink can be adhered thereto.

The curing step is typically a photocuring step. In other words, when the inkjet ink is photocurable, the inkjet ink is cured by irradiating the inkjet ink that has been jetted and landed on the surface of the base material with the active energy rays. Examples of the active energy rays include ultraviolet rays. When ultraviolet rays are used as the active energy rays, a mercury lamp, a metal halide lamp, or the like can be used. In addition, the integrated light amount can be 100 to 10,000 mJ/cm², for example.

When the inkjet ink is thermosetting, the ink is cured by heating with arbitrary means such as hot air current, an oven, and a hot plate.

In regard to this, when the curing step is a photocuring step, heating may be further performed after irradiation with the active energy rays. This heating is performed with the intention of improving adhesiveness, and the like. When this heating is performed, the conditions thereof can be 40° C. to 200° C. for 1 to 60 minutes, for example.

The embodiments of the present invention have been described above, but these are examples of the present invention, and various configurations other than the above embodiments can be adopted. Furthermore, the present invention is not limited to the above-described embodiments, and modifications, improvements, and the like within the scope of achieving the object of the present invention are included in the present invention.

### EXAMPLES

The embodiments of the present invention will be described in detail based on examples and comparative examples. For the sake of precaution, it should be noted that the present invention is not limited to the examples only.

### Preparation of Scale-Like Metal Particles (Metallic Pigment)

The following dispersion liquids of scale-like metal particles (metallic pigment) were prepared. The concentration of each of the dispersion liquids, the average major axis of the scale-like metal particles contained in each of the dispersion liquids, and the like are shown in the table below.
Indium pigment dispersion liquids 1 to 3: indium pigment dispersion liquids obtained from OIKE & Co., Ltd.
Indium pigment dispersion liquid 4: one obtained by surface-treating the indium pigment 2 by a method described below.
Chromium pigment dispersion liquid: a chromium pigment dispersion liquid obtained from OIKE & Co., Ltd.
Aluminum pigment dispersion liquid: an aluminum slurry obtained from Toyo Aluminium K.K.

Surface treatment (surface) modification for obtaining the indium pigment dispersion liquid 4 was performed as follows.

The following (i) to (iii) were mixed and stirred while heating at 70° C. for 1 hour. Thereby, a metallic pigment (scale-like metal particles) surface-modified with a group containing an isostearyl group was obtained.

(i) Indium pigment dispersion liquid 2: 100 parts by mass (20 parts by mass as a solid content)

(ii) Isostearyl acrylate (NK ESTER S-1800A, manufactured by Shin-Nakamura Chemical Co., Ltd.): 0.36 parts by mass

(iii) 3-Aminopropyltrimethoxysilane (KBM-903, manufactured by Shin-Etsu Chemical Co., Ltd.): 0.10 parts by mass

Each of the scale-like metal particles was magnified and captured using a scanning electron microscope (field emission type SEM “S-4800” manufactured by Hitachi High-Technologies Corporation). The major axis (maximum length of each of the particles) and the thickness of 50 arbitrary particles appearing in the captured image were measured. Then, the average major axis and the average thickness were calculated.

In addition, light scattering measurement was also performed on some of the scale-like metal particles under the following conditions. Then, the harmonic average particle diameter (Z-average particle diameter) weighted by an intensity of scattered light was calculated.
Measurement device: Zetasizer Nano ZS (manufactured by Malvern Panalytical Ltd)
Measurement temperature: 25° C.
Cell used: a glass cell
Preparation of measurement samples: for the indium pigment dispersion liquids 1 to 4, samples obtained by diluting each of the dispersion liquids 1,000 times with propylene glycol methyl ether were used as measurement samples. For the chromium pigment dispersion liquid, a sample obtained by diluting 1,000 times with butyl acetate was used as a measurement sample.

### Preparation of Material (Other Than Scale-Like Metal Particles) for Photocationically Curable-Type Inkjet Ink

In order to prepare a photocationically curable-type inkjet ink, the following materials were prepared as materials other than the scale-like metal particles.

TABLE 1

| Raw material name, source of supply, and | |
|---|---|
| the like | Structural formula |
| Aron oxetane OXT-221 (Toagosei Co., Ltd.) | 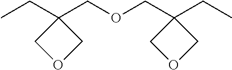 |
| Aron oxetane OXT-101 (Toagosei Co., Ltd.) | 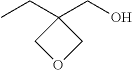 |
| Aron oxetane OXT-212 (Toagosei Co., Ltd.) | 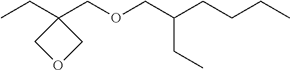 [SMILES: CCCCC(CC)COCC1(CC)COC1] |
| Celloxide 2021P (Daicel Corporation) | 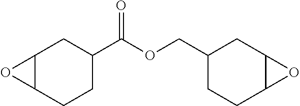 [SMILES: O=C(OCC1CCC2OC2C1)C1CCC2OC2C1] |
| Limonene oxide (Daicel Corporation) | 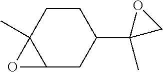 |
| Triisopropanolamine | 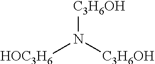 |
| CPI-100P (San-Apro Ltd.) Solution of 50 mass % propylene carbonate | 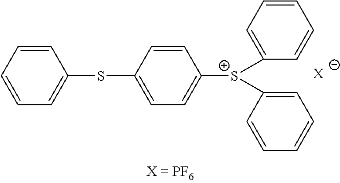 |

### Manufacture of Photocationically Curable-Type Inkjet Ink

The photocationically curable-type inkjet ink was manufactured by thoroughly mixing each of the components shown in the table below.

In the table below, the amount of the scale-like metal particles and the amount of an initiator are shown in terms of solid content amount. In other words, the inkjet inks shown in the table below contain an organic solvent carried over from a solution of an initiator and a dispersion liquid of the scale-like metal particles, in addition to the specified components.

### Evaluation of Photocationically Curable-Type Inkjet Ink

### Curability

Evaluation was performed according to the following procedure.

(1) Using a 6 mil applicator, the inkjet ink was applied to a glass plate (size 10 cm×10 cm×5 mm) so that a thickness was 10 μm. Thereby, an uncured film is formed on the glass plate.

(2) Using a high-pressure mercury lamp (UB041-5A/B, 60 Hz, manufactured by EYE GRAPHICS Co., Ltd.), the above-mentioned uncured film was irradiated with ultraviolet rays under the condition of an integrated light amount of 500 mJ/cm². Thereby, the uncured film became a cured film.

(3) The cured state of the cured film was evaluated according to the following evaluation criteria.

5 points: sufficiently cured, and there was no tackiness.

4 points: there was tackiness, but no fingerprint remained even when touched with a finger.

3 points: there was tackiness, and fingerprints remained when touched with a finger.

2 points: the paint component adhered to a finger when the coating film was touched with a finger, but the viscosity was increased (meaning cured).

1 point: not cured at all.

### Viscosity

Using an E-type viscometer (RE-85 type viscometer manufactured by Toki Sangyo Co., Ltd), the viscosity was measured at 100 rpm and 25° C. according to JIS K 7117-1.

### Evaluation of Printed Material Using Photocationically Curable-Type Inkjet Ink

### Production of Printed Material for Metallic Gloss and Total Light Transmittance (Transparency Evaluation)

As an inkjet printer, an inkjet printer (manufactured by TRITEK CO., LTD., Stage JET) equipped with a piezo type inkjet head (manufactured by Konica Minolta, Inc., KM1024iL, ink liquid droplet volume of 32 pL) was prepared.

Using this printer, printing (base-exposure printing) was performed by jetting the inkjet ink onto a glass plate (10 cm×10 cm×2 mm) under the conditions of a head temperature of 45° C., a resolution of 720 dpi, and 8-division multipass. Immediately thereafter, irradiation with ultraviolet rays was performed to cure the ink. Thereafter, heating was further performed at 120° C. for 3 minutes. As above, a test plate (printed material for evaluation) for evaluating the external appearance and the durability of the printed material was obtained.

Irradiation with ultraviolet rays after the base-exposure printing was performed by irradiating with ultraviolet rays under the condition of an irradiation dose of 500 mJ/cm² after about 1 second from the jetting of the ink using a device attached to the above-mentioned printer.

### Metallic Glossiness: 60° Gloss Value

The metallic glossiness was evaluated by the 60° gloss value. Specifically, the 60° gloss of the obtained printed material for evaluation was measured with a glossmeter “Micro-Gloss” manufactured by BYK-Gardner GmbH.

### Total Light Transmittance (Transparency Evaluation)

Measurement was performed using a haze meter NDH 4000 manufactured by NIPPON DENSHOKU INDUSTRIES CO., LTD. according to JIS K 7361-1.

### Evaluation of Satellite Droplets

As an inkjet printer, an inkjet printer (manufactured by TRITEK CO., LTD., Stage JET) equipped with a piezo type inkjet head (manufactured by Konica Minolta, Inc., KM1024iL, ink liquid droplet volume of 32 pL) was prepared. Using this printer, a straight line with a width of 2 mm was drawn under the following conditions. Thereby, a printed material for satellite droplet evaluation was obtained.

### Conditions

Head temperature: 45° C.

Resolution: 720 dpi

Print speed: 740 mm/sec

Head gap: 2 mm

8-Division multipass printer

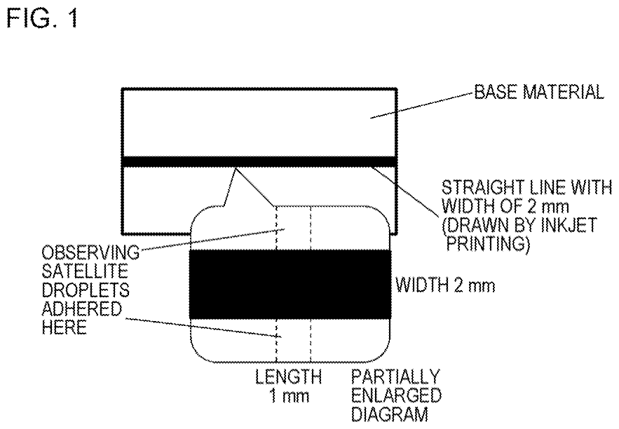

A region with a length of 1 mm and its edge part (also refer to FIG. 1), which were on the straight line with a width of 2 mm drawn on the printed material for satellite droplet evaluation, were observed using a microscope. Then, the adhesion state of the satellite droplets at the edge part of the straight line was evaluated by scoring according to the following criteria.

### Number Evaluation

5 points: the adhesion number of the satellite droplets observed was less than 10

4 points: the adhesion number of the satellite droplets observed was equal to or more than 10 and less than 20

3 points: the adhesion number of the satellite droplets observed was equal to or more than 20 and less than 30

2 points: the adhesion number of the satellite droplets observed was equal to or more than 30 and less than 50

1 point: the adhesion number of the satellite droplets observed was equal to or more than 50

### Flying Distance Evaluation: the Distance From the Straight Line of the Satellite Droplets Adhered Farthest From the Drawn Straight Line

5 points: less than 0.5 mm

4 points: equal to or more than 0.5 mm and less than 1.0 m

3 points: equal to or more than 1.0 mm and less than 1.5 mm

2 points: equal to or more than 1.5 mm and less than 3.0 mm

1 point: equal to or more than 3.0 mm

The composition of the inkjet ink and the evaluation results are collectively shown in the table below.

TABLE 2

| | | Average | | Z-average | | | | |
|---|---|---|---|---|---|---|---|---|
| | Solid | major | | particle | | | | |
| | content | axis | Thickness | diameter | Example | Example | Example | Example |
| Number of example/comparative example | (mass %) | (nm) | (nm) | (nm) | 1-1 | 1-2 | 1-3 | 1-4 |

| | | | | | | | |
|---|---|---|---|---|---|---|---|
| Inkjet ink | Binder | Oxetane | OXT-221 | 18 | 18 | 18 | 18 |
| (unit of | component | compound | OXT-101 | 13 | 13 | 13 | 13 |
| numerical | | | OXT-212 | | | | |
| value: | | Epoxy | Celloxide 2021P | 55 | 55 | 55 | 55 |
| parts by | | compound | Limonene oxide | 14 | 14 | 14 | 14 |

| | | | | | |
|---|---|---|---|---|---|
| mass unless | Total amount of binder components | 100 | 100 | 100 | 100 |

| otherwise | Amine | Triisopropanolamine | | | | | 0.1 | 0.1 | 0.1 | 0.1 |
|---|---|---|---|---|---|---|---|---|---|---|
| specified) | Initiator | CPI-100P | | | | | 4 | 4 | 4 | 4 |
| | Scale-like | Indium | 20% | 127 | 33 | 118 | 4 | | | |
| | metal | pigment | | | | | | | | |
| | particles | dispersion | | | | | | | | |
| | (dispersion | liquid 1 | | | | | | | | |
| | liquid) | (non-surface- | | | | | | | | |

| | | | | | | | |
|---|---|---|---|---|---|---|---|
| treated) | | | | | | | |
| Indium | 20% | 164 | 36 | 208 | 4 | | |
| pigment | | | | | | | |
| dispersion | | | | | | | |
| liquid 2 | | | | | | | |
| (non-surface- | | | | | | | |
| treated) | | | | | | | |
| Indium | 20% | 241 | 36 | (Not | | 4 | |
| pigment | | | | measured) | | | |
| dispersion | | | | | | | |
| liquid 3 | | | | | | | |
| (non-surface- | | | | | | | |
| treated) | | | | | | | |
| Indium | 20% | 166 | 37 | (Not | | | 4 |
| pigment | | | | measured) | | | |
| dispersion | | | | | | | |
| liquid | | | | | | | |
| (surface- | | | | | | | |
| treated) | | | | | | | |
| Chromium | 10% | 340 | 35 | 359 | | | |
| pigment | | | | | | | |
| dispersion | | | | | | | |
| liquid | | | | | | | |
| (non-surface- | | | | | | | |
| treated) | | | | | | | |
| Aluminum | 10% | 840 | 53 | 777 | | | |
| pigment | | | | | | | |
| dispersion | | | | | | | |
| liquid | | | | | | | |
| (non-surface- | | | | | | | |
| treated) | | | | | | | |

| | | | | |
|---|---|---|---|---|
| Ratio of scale-like metal particles in total | 3.7 | 3.7 | 3.7 | 3.7 |
| amount of nonvolatile components (mass %) | | | | |
| Ratio of scale-like metal particles | 3.2 | 3.2 | 3.2 | 3.2 |
| in total amount of ink (mass %) | | | | |

| Evaluation of | Curability | | 5 | 5 | 5 | 5 |
|---|---|---|---|---|---|---|
| inkjet ink | Viscosity (mPa · s) | | 12.7 | 12.8 | 12.7 | 12.6 |
| Evaluation of | Metallic glossiness: | | 244 | 250 | 258 | 280 |
| printed material | 60° gloss value | | | | | |
| | Total light transmittance | | 2.5 | 2.6 | 2.8 | 2.9 |
| | (transparency evaluation) | | | | | |
| | Satellite | Number evaluation | 5 | 5 | 4 | 5 |
| | evaluation | (1 to 5 points) | | | | |
| | | Flying distance evaluation | 5 | 4 | 4 | 5 |
| | | (1 to 5 points) | | | | |

| | | Average | | Z-average | | | | |
|---|---|---|---|---|---|---|---|---|
| | Solid | major | | particle | | | | |
| | content | axis | Thickness | diameter | Example | Example | Example | Example |
| Number of example/comparative example | (mass %) | (nm) | (nm) | (nm) | 1-5 | 1-6 | 1-7 | 1-8 |

| | | | | | | | |
|---|---|---|---|---|---|---|---|
| Inkjet ink | Binder | Oxetane | OXT-221 | 18 | 12 | 77 | |
| (unit of | component | compound | OXT-101 | 13 | 13 | 13 | |
| numerical | | | OXT-212 | | 21 | | |
| value: | | Epoxy | Celloxide 2021P | 55 | 40 | 10 | 70 |
| parts by | | compound | Limonene oxide | 14 | 14 | | 30 |

| | | | | | |
|---|---|---|---|---|---|
| mass unless | Total amount of binder components | 100 | 100 | 100 | 100 |

| otherwise | Amine | Triisopropanolamine | | | | | 0.1 | 0.1 | 0.1 | 0.1 |
|---|---|---|---|---|---|---|---|---|---|---|
| specified) | Initiator | CPI-100P | | | | | 4 | 4 | 4 | 4 |
| | Scale-like | Indium | 20% | 127 | 33 | 118 | | 4 | 4 | 4 |
| | metal | pigment | | | | | | | | |
| | particles | dispersion | | | | | | | | |
| | (dispersion | liquid 1 | | | | | | | | |
| | liquid) | (non-surface- | | | | | | | | |

| | | | | | |
|---|---|---|---|---|---|
| treated) | | | | | |
| Indium | 20% | 164 | 36 | 208 | |
| pigment | | | | | |
| dispersion | | | | | |
| liquid 2 | | | | | |
| (non-surface- | | | | | |
| treated) | | | | | |
| Indium | 20% | 241 | 36 | (Not | |
| pigment | | | | measured) | |
| dispersion | | | | | |
| liquid 3 | | | | | |
| (non-surface- | | | | | |
| treated) | | | | | |
| Indium | 20% | 166 | 37 | (Not | |
| pigment | | | | measured) | |
| dispersion | | | | | |
| liquid | | | | | |
| (surface- | | | | | |
| treated) | | | | | |
| Chromium | 10% | 340 | 35 | 359 | 4 |
| pigment | | | | | |
| dispersion | | | | | |
| liquid | | | | | |
| (non-surface- | | | | | |
| treated) | | | | | |
| Aluminum | 10% | 840 | 53 | 777 | |
| pigment | | | | | |
| dispersion | | | | | |
| liquid | | | | | |
| (non-surface- | | | | | |
| treated) | | | | | |

| | | | | |
|---|---|---|---|---|
| Ratio of scale-like metal particles in total | 3.7 | 3.7 | 3.7 | 3.7 |
| amount of nonvolatile components (mass %) | | | | |
| Ratio of scale-like metal particles | 2.8 | 3.2 | 3.2 | 3.2 |
| in total amount of ink (mass %) | | | | |

| Evaluation of | Curability | | 5 | 4 | 3 | 5 |
|---|---|---|---|---|---|---|
| inkjet ink | Viscosity (mPa · s) | | 12.6 | 11.9 | 10.9 | 13.8 |
| Evaluation of | Metallic glossiness: | | 182 | 235 | 255 | 197 |
| printed material | 60° gloss value | | | | | |
| | Total light transmittance | | 2.8 | 2.6 | 2.5 | 2.8 |
| | (transparency evaluation) | | | | | |
| | Satellite | Number evaluation | 3 | 5 | 5 | 5 |
| | evaluation | (1 to 5 points) | | | | |
| | | Flying distance evaluation | 3 | 5 | 5 | 5 |
| | | (1 to 5 points) | | | | |

| | | Average | | Z-average | | | |
|---|---|---|---|---|---|---|---|
| | Solid | major | | particle | | | |
| | content | axis | Thickness | diameter | Example | Example | Comparative |
| Number of example/comparative example | (mass %) | (nm) | (nm) | (nm) | 1-9 | 1-10 | Example 1-1 |

| | | | | | | |
|---|---|---|---|---|---|---|
| Inkjet ink | Binder | Oxetane | OXT-221 | 18 | 18 | 18 |
| (unit of | component | compound | OXT-101 | 13 | 13 | 13 |
| numerical | | | OXT-212 | | | |
| value: | | Epoxy | Celloxide 2021P | 55 | 55 | 55 |
| parts by | | compound | Limonene oxide | 14 | 14 | 14 |

| | | | | |
|---|---|---|---|---|
| mass unless | Total amount of binder components | 100 | 100 | 100 |

| | | | | | |
|---|---|---|---|---|---|
| otherwise | Amine | Triisopropanolamine | 0.1 | 0.1 | 0.1 |
| specified) | Initiator | CPI-100P | 4 | 4 | 4 |

| | | | | | | | |
|---|---|---|---|---|---|---|---|
| Scale-like | Indium | 20% | 127 | 33 | 118 | 3 | 6 |
| metal | pigment | | | | | | |
| particles | dispersion | | | | | | |
| (dispersion | liquid 1 | | | | | | |
| liquid) | (non-surface- | | | | | | |

| | | | | | |
|---|---|---|---|---|---|
| treated) | | | | | |
| Indium | 20% | 164 | 36 | 208 | |
| pigment | | | | | |
| dispersion | | | | | |
| liquid 2 | | | | | |
| (non-surface- | | | | | |
| treated) | | | | | |
| Indium | 20% | 241 | 36 | (Not | |
| pigment | | | | measured) | |
| dispersion | | | | | |
| liquid 3 | | | | | |
| (non-surface- | | | | | |
| treated) | | | | | |
| Indium | 20% | 166 | 37 | (Not | |
| pigment | | | | measured) | |
| dispersion | | | | | |
| liquid | | | | | |
| (surface- | | | | | |
| treated) | | | | | |
| Chromium | 10% | 340 | 35 | 359 | |
| pigment | | | | | |
| dispersion | | | | | |
| liquid | | | | | |
| (non-surface- | | | | | |
| treated) | | | | | |
| Aluminum | 10% | 840 | 53 | 777 | 4 |
| pigment | | | | | |
| dispersion | | | | | |
| liquid | | | | | |
| (non-surface- | | | | | |
| treated) | | | | | |

| | | | |
|---|---|---|---|
| Ratio of scale-like metal particles in total | 2.8 | 5.4 | 3.7 |
| amount of nonvolatile components (mass %) | | | |
| Ratio of scale-like metal particles | 2.5 | 4.5 | 2.8 |
| in total amount of ink (mass %) | | | |

| | | | | |
|---|---|---|---|---|
| Evaluation of | Curability | 5 | 4 | 4 |
| inkjet ink | Viscosity (mPa · s) | 12.6 | 13.5 | 12.8 |
| Evaluation of | Metallic glossiness: | 232 | 266 | 350 |
| printed material | 60° gloss value | | | |

| Total light transmittance | | 5.2 | 2.1 | 2.8 |
|---|---|---|---|---|
| (transparency evaluation) | | | | |
| Satellite | Number evaluation | 5 | 5 | 1 |
| evaluation | (1 to 5 points) | | | |
| | Flying distance evaluation | 5 | 4 | 1 |
| | (1 to 5 points) | | | |

As shown in the table above, in each example, by using the inkjet ink containing 2 to 10 mass % of the scale-like metal particles having an average major axis of equal to or less than 400 nm, an image having a high level of metallic gloss could be provided while preventing the generation of satellite droplets. In other words, it was possible to achieve compatibility between two performances which were a high level of metallic gloss of the printed image and the preventing of the generation of satellite droplets, which were difficult to achieve at the same time.

On the other hand, in Comparative Example 1-1 using the scale-like metal particles having an average major axis of more than 400 nm, although an image having a high level of metallic gloss could be obtained, the evaluation score for satellite droplets was low.

A more detailed analysis of the above table reveals that when the scale-like metal particles having an average major axis of equal to or less than 200 nm were used, the number evaluation in the evaluation of satellite droplets was 5 points. On the other hand, when the scale-like metal particles having an average major axis of 200 to 400 nm were used, the number evaluation in the evaluation of satellite droplets was 3 points or 4 points (Examples 1-3 and 1-5). It is understood that the use of the scale-like metal particles having an average major axis of equal to or less than 200 nm can further reduce the problem of satellite droplets.

Furthermore, Example 1-4 in which the indium pigment 4 as surface-modified particles was used showed particularly favorable metallic gloss.

### Preparation of Material (Other Than Scale-Like Metal Particles) for Photoradically Curable-Type Inkjet Ink

In order to prepare a photoradically curable-type inkjet ink, the following materials were prepared as materials other than the scale-like metal particles.

TABLE 3

| Raw material name, source of supply, and | |
|---|---|
| the like | Structural formula |
| NK ESTER A-HD-N (Shin-Nakamura Chemical Co., Ltd.) | 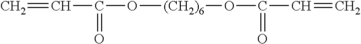 |
| A-TMPT (Shin-Nakamura Chemical Co., Ltd.) | CH₃—CH₂—C(CH₂OOC—CH═CH₂)₃ |
| Omnirad 184 (IGM Resins B.V.) * Solvent-free | 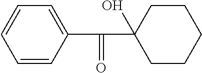 [SMILES: O=C(c1ccccc1)C1(O)CCCCC1] |

### Manufacture of Photoradically Curable-Type Inkjet Ink

The photoradically curable-type inkjet ink was manufactured by thoroughly mixing each of the components shown in the table below.

In the table below, the scale-like metal particles are the same as those used in the above-mentioned photocationically curable-type inkjet ink.

### Evaluation of Photoradically Curable-Type Inkjet Ink

### Curability

Evaluation was performed on a 5-point scale in the same manner as for the photocationically curable-type inkjet ink.

### Viscosity

Measurement was performed in the same manner as for the photocationically curable-type inkjet ink.

### Evaluation of Printed Material Using Photoradically Curable-Type Inkjet Ink

### Production of Printed Material for Evaluation, Metallic Glossiness: 60° Gloss Value, Total Light Transmittance (Transparency Evaluation), Evaluation of Satellite Droplets)

In the same manner as in the case of the photocationically curable-type inkjet ink, a printed material for evaluation was produced to perform evaluation by scoring, and the like.

The composition, the evaluation results, and the like of the photoradically curable-type inkjet ink are collectively shown in the table below.

TABLE 4

| | | | | | Average | | | | | |
|---|---|---|---|---|---|---|---|---|---|---|
| | | | | | maximum | | Z-average | | | |
| | | | | Solid | major | | particle | | | |
| | | | | content | axis | Thickness | diameter | Example | Example | Example |
| Number of example/comparative example | | | | (mass %) | (nm) | (nm) | (nm) | 2-1 | 2-2 | 2-3 |
| Inkjet ink | Binder | Acrylic | NK ESTER A-HD-N | | | | | 91 | 91 | 91 |
| composition | component | compound | A-TMPT | | | | | 9 | 9 | 9 |
| (unit of | | Total amount of binder components | | | | | | 100 | 100 | 100 |
| numerical | Photoradical | | Omnirad 184 | | | | | 4 | 4 | 4 |
| value: | initiator | | | | | | | | | |
| parts by | Scale-like | | Indium | 20% | 127 | 33 | 118 | 4 | | |
| mass unless | metal | | pigment | | | | | | | |
| otherwise | particles | | dispersion | | | | | | | |
| specified) | | | liquid 1 | | | | | | | |
| | | | (non-surface- | | | | | | | |
| | | | treated) | | | | | | | |
| | | | Indium | 20% | 164 | 36 | 208 | | 4 | |
| | | | pigment | | | | | | | |
| | | | dispersion | | | | | | | |
| | | | liquid 2 | | | | | | | |
| | | | (non-surface- | | | | | | | |
| | | | treated) | | | | | | | |
| | | | Indium | 20% | 241 | 36 | (Not | | | 4 |
| | | | pigment | | | | measured) | | | |
| | | | dispersion | | | | | | | |
| | | | liquid 3 | | | | | | | |
| | | | (non-surface- | | | | | | | |
| | | | treated) | | | | | | | |
| | | | Indium | 20% | 166 | 37 | (Not | | | |
| | | | pigment | | | | measured) | | | |
| | | | dispersion | | | | | | | |
| | | | liquid 4 | | | | | | | |
| | | | (surface- | | | | | | | |
| | | | treated) | | | | | | | |
| | | | Chromium | 10% | 340 | 35 | 359 | | | |
| | | | pigment | | | | | | | |
| | | | dispersion | | | | | | | |
| | | | liquid | | | | | | | |
| | | | (non-surface- | | | | | | | |
| | | | treated) | | | | | | | |

| | | | |
|---|---|---|---|
| Ratio of scale-like metal particles in total | 3.7 | 3.7 | 3.7 |
| amount of nonvolatile components (mass %) | | | |
| Ratio of scale-like metal particles | 3.2 | 3.2 | 3.2 |
| in total amount of ink (mass %) | | | |

| Evaluation of | Curability | | 5 | 5 | 5 |
|---|---|---|---|---|---|
| inkjet ink | Viscosity (mPa · s) | | 17.7 | 17.7 | 17.6 |
| Evaluation of | Metallic glossiness: | | 251 | 252 | 259 |
| printed material | 60° gloss value | | | | |
| | Total light transmittance | | 2.7 | 2.7 | 2.7 |
| | (transparency evaluation) | | | | |
| | Satellite evaluation | | 5 | 5 | 4 |
| | Satellite | Number evaluation | 5 | 5 | 4 |
| | evaluation | (1 to 5 points) | | | |
| | | Flying distance evaluation | 5 | 4 | 4 |
| | | (1 to 5 points) | | | |

| | | | | | Average | | | | |
|---|---|---|---|---|---|---|---|---|---|
| | | | | | maximum | | Z-average | | |
| | | | | Solid | major | | particle | | |
| | | | | content | axis | Thickness | diameter | Example | Example |
| Number of example/comparative example | | | | (mass %) | (nm) | (nm) | (nm) | 2-4 | 2-5 |
| Inkjet ink | Binder | Acrylic | NK ESTER A-HD-N | | | | | 91 | 91 |
| composition | component | compound | A-TMPT | | | | | 9 | 9 |
| (unit of | | Total amount of binder components | | | | | | 100 | 100 |
| numerical | Photoradical | | Omnirad 184 | | | | | 4 | 4 |
| value: | initiator | | | | | | | | |
| parts by | Scale-like | | Indium | 20% | 127 | 33 | 118 | | |
| mass unless | metal | | pigment | | | | | | |
| otherwise | particles | | dispersion | | | | | | |
| specified) | | | liquid 1 | | | | | | |
| | | | (non-surface- | | | | | | |
| | | | treated) | | | | | | |
| | | | Indium | 20% | 164 | 36 | 208 | | |
| | | | pigment | | | | | | |
| | | | dispersion | | | | | | |
| | | | liquid 2 | | | | | | |
| | | | (non-surface- | | | | | | |
| | | | treated) | | | | | | |
| | | | Indium | 20% | 241 | 36 | (Not | | |
| | | | pigment | | | | measured) | | |
| | | | dispersion | | | | | | |
| | | | liquid 3 | | | | | | |
| | | | (non-surface- | | | | | | |
| | | | treated) | | | | | | |
| | | | Indium | 20% | 166 | 37 | (Not | 4 | |
| | | | pigment | | | | measured) | | |
| | | | dispersion | | | | | | |
| | | | liquid 4 | | | | | | |
| | | | (surface- | | | | | | |
| | | | treated) | | | | | | |
| | | | Chromium | 10% | 340 | 35 | 359 | | 4 |
| | | | pigment | | | | | | |
| | | | dispersion | | | | | | |
| | | | liquid | | | | | | |
| | | | (non-surface- | | | | | | |
| | | | treated) | | | | | | |

| | | |
|---|---|---|
| Ratio of scale-like metal particles in total | 3.7 | 3.7 |
| amount of nonvolatile components (mass %) | | |
| Ratio of scale-like metal particles | 3.2 | 2.8 |
| in total amount of ink (mass %) | | |

| | | | |
|---|---|---|---|
| Evaluation of | Curability | 4 | 5 |
| inkjet ink | Viscosity (mPa · s) | 17.7 | 17.5 |
| Evaluation of | Metallic glossiness: | 278 | 181 |
| printed material | 60° gloss value | | |

| Total light transmittance | | 3.1 | 2.8 |
|---|---|---|---|
| (transparency evaluation) | | | |
| Satellite evaluation | | 5 | 3 |
| Satellite | Number evaluation | 5 | 3 |
| evaluation | (1 to 5 points) | | |
| | Flying distance evaluation | 5 | 3 |
| | (1 to 5 points) | | |

From the above table, not only in the photocationically curable-type but also in the photoradically curable-type, by preparing the inkjet ink containing 2 to 10 mass % of the scale-like metal particles having an average major axis of equal to or less than 400 nm, an image having a high level of metallic gloss could be provided while preventing the generation of satellite droplets.

This application claims the priority on the basis of Japanese application Japanese Patent Application No. 2020-150318 filed Sep. 8, 2020, the entire disclosure of which is incorporated herein by reference.

1. An inkjet ink comprising:
scale-like metal particles,
wherein an average major axis of the scale-like metal particles is equal to or less than 400 nm, and
the inkjet ink contains 2 to 10 mass % of the scale-like metal particles.

2. The inkjet ink according to claim 1,
wherein the average major axis of the scale-like metal particles is 50 to 200 nm.

3. The inkjet ink according to claim 1,
wherein the scale-like metal particles include indium and/or chromium.

4. The inkjet ink according to claim 1,
wherein the scale-like metal particles are surface-modified with a group including a linear or branched alkyl group having 4 or more carbon atoms, a silicon atom-containing group, or a fluorine atom-containing group.

5. The inkjet ink according to claim 1,
wherein the scale-like metal particles are not surface-modified.

6. The inkjet ink according to claim 1, further comprising:
a radically polymerizable compound; and
a radical polymerization initiator.

7. The inkjet ink according to claim 6,
wherein the radically polymerizable compound includes a compound having a (meth)acryloyl group.

8. The inkjet ink according to claim 1, further comprising:
a cationically polymerizable compound; and
a cationic polymerization initiator.

9. The inkjet ink according to claim 8,
wherein the cationically polymerizable compound includes a compound having an epoxy group and/or an oxetanyl group.

10. The inkjet ink according to claim 1,
wherein the inkjet ink is photocurable.

11. A method for manufacturing a printed material, the method comprising:
an image forming step of jetting the inkjet ink according to claim 1, onto a surface of a base material to form an image; and
a curing step of curing the jetted inkjet ink.

12. A printed material comprising:
a cured product of the inkjet ink according to claim 1.
